(19) United States
(12) Patent Application Publication
(10) Pub. No.: US 2023/0089446 A1
(43) Pub. Date: Mar. 23, 2023

(54) BEAM STATE UPDATING IN WIRELESS COMMUNICATION

(71) Applicant: ZTE Corporation, Shenzhen (CN)

(72) Inventors: Ke YAO, Shenzhen (CN); Bo GAO, Shenzhen (CN); Zhaohua LU, Shenzhen (CN); Chuangxin JIANG, Shenzhen (CN); Wenjun YAN, Shenzhen (CN)

(73) Assignee: ZTE Corporation, Shenzhen (CN)

(21) Appl. No.: 18/060,443

(22) Filed: Nov. 30, 2022

Related U.S. Application Data
(63) Continuation of application No. PCT/CN2020/094509, filed on Jun. 5, 2020.

(51) Int. Cl. H04W 72/12; H04B 7/06; H04L 5/00

(52) U.S. Cl. CPC H04W 72/1289; H04B 7/0695; H04L 5/0053

(57) ABSTRACT

This document generally relates to wireless communication schemes that include determining a beam state for transmission of a second signal based on a downlink control information (DCI) command that is used for scheduling transmission of a first signal. In some embodiments, whether to communicate the first signal is also determined.

### CROSS-REFERENCE TO RELATED APPLICATIONS

This application is a continuation of International Patent Application No. PCT/CN2020/094509, filed Jun. 5, 2020. The contents of International Patent Application No. PCT/CN2020/094509 are herein incorporated by reference in their entirety.

### TECHNICAL FIELD

This document is directed generally to wireless communications.

### BACKGROUND

A key objective of new radio (NR) technology of fifth generation (5G) mobile communication systems is to support high frequency bands, which have abundantly more frequency domain resources compared to lower frequency bands. However, higher frequency signals attenuate more rapidly and provide a lower range of coverage. To improve these deficiencies, devices utilizing 5G NR are configured with antennas capable of performing beamforming in order to concentrate energy in a relatively small spatial range. In turn, the beams determined by two devices communicating with each other form a beam pair.

During communication, the time and/or position of at least one of the devices may change, which may or may not require the beam pair to change in order for the devices to maintain optimal communication settings. Also, during communication, the devices may communicate different control and data signals and channels, which may require the same or different beam pairs and/or other communication setting or parameters for optimal communication. As such, flexible ways for devices to determine communication settings and parameters during wireless communication in 5G NR or other wireless communication systems may be desirable.

### SUMMARY

This document relates to methods, systems, and devices for communicating a second signal according to a beam state determined from a DCI command used to schedule a transmission of a first signal. In some implementations, a method for wireless communication, includes: receiving, by a first node, a downlink control information (DCI) command, wherein the DCI command is used for scheduling a transmission of a first signal; determining, by the first node, a beam state for a transmission of a second signal based on the DCI command; and communicating, by the first node, the second signal with a second node according to the beam state.

In some of these implementations, the method further includes the first node determining the beam state for the transmission of the second signal according to a second transmission parameter.

In some of these implementations, the method further includes the first node determining the beam state for the transmission of the second signal after a predetermined time point, or after a predetermined time period after the predetermined time point.

In some of these implementations, the method further includes the first node determining whether to communicate the first signal.

In some other implementations, a device, such as a network device, is disclosed. The device may include one or more processors and one or more memories, wherein the one or more processors are configured to read computer code from the one or more memories to implement any one of the methods above.

In yet some other implementations, a computer program product is disclosed. The computer program product may include a non-transitory computer-readable program medium with computer code stored thereupon, the computer code, when executed by one or more processors, causing the one or more processors to implement any one of the methods above.

The above and other aspects and their implementations are described in greater detail in the drawings, the descriptions, and the claims.

### BRIEF DESCRIPTION OF THE DRAWINGS

FIG. 1 shows an example of a wireless communication system.

FIG. 2 shows example layers of a communication node of the wireless communication system of FIG. 1.

FIG. 3 is a flow chart of an example of a wireless communication method.

FIG. 4 is a flow chart of another example of a wireless communication method.

### DETAILED DESCRIPTION

The present description describes systems, apparatuses, and methods for wireless communication that determine a beam state for transmission of a second signal between multiple nodes in a wireless system based on a downlink control information (DCI) command used to schedule transmission of a first signal. Additionally, various embodiments may further include determining whether to perform the first signal transmission, determining the beam state to perform the second transmission according to a second transmission parameter, and/or determining when to use the beam state for the second transmission. Overhead and resources may be reduced under such wireless communication schemes. Such wireless communication schemes may be particularly advantageous for wireless systems that have relatively large signaling overhead to update the beam states, and for nodes that have multi-panel and/or multi-transmission and reception point (TRP) configurations, such as configured to communicate according to New Radio (NR) technology.

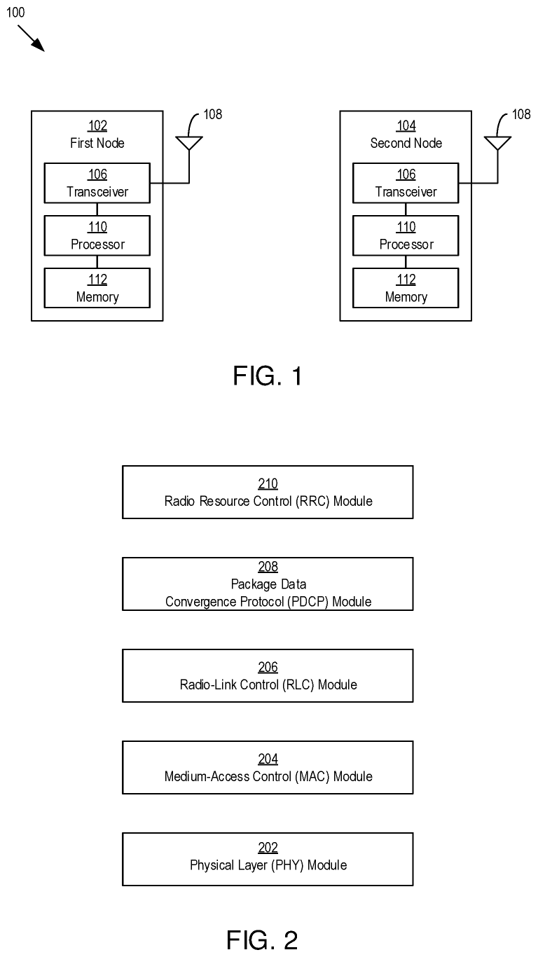

In further detail, FIG. 1 shows a diagram of an example wireless communication system 100 including a plurality of communication nodes that are configured to wirelessly communicate with each other. The communication nodes include a first node 102 and a second node 104. Various other examples of the wireless communication system 100 may include more than two communication nodes.

In general, each communication node is an electronic device, or a plurality (or network or combination) of electronic devices, that is configured to wirelessly communicate with another node in the wireless communication system, including wirelessly transmitting and receiving signals. In various embodiments, each communication node may be one of a plurality of types of communication nodes.

One type of communication node is a user device. A user include a single electronic device or apparatus, or multiple (e.g., a network of) electronic devices or apparatuses, capable of communicating wirelessly over a network. A user device may include or otherwise be referred to as a user terminal or a user equipment (UE). Additionally, a user device may be or include, but not limited to, a mobile device (such as a mobile phone, a smart phone, a tablet, or a laptop computer, as non-limiting examples) or a fixed or stationary device, (such as a desktop computer or other computing devices that are not ordinarily moved for long periods of time, such as appliances, other relatively heavy devices including Internet of things (IoT), or computing devices used in commercial or industrial environments, as non-limiting examples).

A second type of communication node is a wireless access node. A wireless access node may comprise one or more base stations or other wireless network access points capable of communicating wirelessly over a network with one or more user devices and/or with one or more other wireless access nodes. For example, the wireless access node 104 may comprise a 4G LTE base station, a 5G NR base station, a 5G central-unit base station, a 5G distributed-unit base station, a next generation Node B (gNB), an enhanced Node B (eNB), or other base station, or network in various embodiments.

As shown in FIG. 1, each communication node 102, 104 may include transceiver circuitry 106 coupled to an antenna 108 to effect wireless communication. The transceiver circuitry 106 may also be coupled to a processor 110, which may also be coupled to a memory 112 or other storage device. The processor 110 may be configured in hardware (e.g., digital logic circuitry, field programmable gate arrays (FPGA), application specific integrated circuits (ASIC), or the like), and/or a combination of hardware and software (e.g., hardware circuitry (such as a central processing unit (CPU)) configured to execute computer code in the form of software and/or firmware to carry out functions). The memory 112, which may be in the form of volatile memory, non-volatile memory, combinations thereof, or other types of memory, may be implemented in hardware, and may store therein instructions or code that, when read and executed by the processor 110, cause the processor 110 to implement various functions and/or methods described herein. Also, in various embodiments, the antenna 108 may include a plurality of antenna elements that may each have an associated phase and/or amplitude that can be controlled and/or adjusted, such as by the processor 110. Through this control, a communication node may be configured to have transmit-side directivity and/or receive-side directivity, in that the processor 110, and/or the transceiver circuitry 106, can perform beam forming by selecting a beam from among a plurality of possible beams, and transmit or receive a signal with the antenna radiating the selected beam.

Additionally, in various embodiments, the communication nodes 102, 104 may be configured to wirelessly communicate with each other in or over a mobile network and/or a wireless access network according to one or more standards and/or specifications. In general, the standards and/or specifications may define the rules or procedures under which communication nodes 102, 104 can wirelessly communicate, which may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

In the wireless system 100, the communication nodes 102, 104 are configured to wirelessly communicate signals between each other. In general, a communication in the wireless system 100 between two communication nodes can be or include a transmission or a reception, and is generally both simultaneously, depending on the perspective of a particular node in the communication. For example, for a communication between the first node 102 and the second node 104, where the first node 102 is transmitting a signal to the second node 104 and the second node 104 is receiving the signal from the first node 102, the communication may be considered a transmission for the first node 102 and a reception for the second node 104. Similarly, where the second node 104 is transmitting a signal to the first node 102 and the first node 102 is receiving the signal from the second node 102, the communication may be considered a transmission for the second node 104 and a reception for the first node 102. Accordingly, depending on the type of communication and the perspective of a particular node, when a first node is communicating a signal with a second node, the node is either transmitting the signal or receiving the signal. Hereafter, for simplicity, communications between two nodes are generally referred to as transmissions.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, particular signals can be characterized or defined as either an uplink (UL) signal or a downlink (DL) signal. An uplink signal is a signal transmitted from a user device to the wireless access node. A downlink signal is a signal transmitted from a wireless access node to a user device. Also, certain signals may defined or characterized by combinations of data/control and uplink/downlink, including uplink control signals, uplink data signals, downlink control signals, and downlink data signals.

For at least some specifications, such as 5G NR, an uplink control signal is also referred to as a physical uplink control channel (PUCCH), an uplink data signal is also referred to as a physical uplink shared channel (PUSCH), a downlink control signal is also referred to as a physical downlink control channel (PDCCH), and a downlink data signal is also referred to as a physical downlink shared channel (PDSCH).

Also, some signals communicated in the system 100 may be defined or characterized as reference signals (RS). In general, a reference signal may be recognized in the system 100 as a signal other than a shared channel signal or a control signal, although a reference signal may be an uplink reference signal or a downlink reference signal. Non-limiting examples of reference signals used herein, and as defined at least in 5G NR, include a demodulation reference signal (DM-RS), a channel-state information reference signal (CSI-RS), and a sounding reference signal (SRS). A DM-RS is used for channel estimation to allow for coherent demodulation. For example, a DMRS for a PUSCH transmission allows a wireless access node to coherently demodulate the uplink shared channel signal. A CSI-RS is a downlink reference signal used by a user device to acquire downlink channel state information (CSI). A SRS is an uplink reference signal transmitted by a user device and used by a wireless access node for uplink channel-state estimation.

Additionally, a signal may have an associated resource that, in general, provides or identifies time and/or frequency characteristics for transmission of the signal. An example time characteristic is a temporal positioning of a smaller time unit over which the signal spans, or that the signal occupies, within a larger time unit. In certain transmission schemes, such as orthogonal frequency-division multiplexing (OFDM), a time unit can be a sub-symbol (e.g., a OFDM sub-symbol), a symbol (e.g., a OFDM symbol), a slot, a sub-frame, a frame, or a transmission occasion. An example frequency characteristic is a frequency band or a sub-carrier in or over which the signal is carried. Accordingly, as an example illustration, for a signal spanning N symbols, a resource for the signal may identify a positioning of the N symbols within a larger time unit (such as a slot) and a subcarrier in or over which the signal is carried.

FIG. 2 shows a block diagram of a plurality of modules of a communication node, including a physical layer (PHY) module 202, a medium-access control (MAC) module 204, a radio-a link control (RLC) module 206, a package data convergence protocol (PDCP) module 208, and a radio resource control (RRC) module 210. In general, as used herein, a module is an electronic device, such as electronic circuit, that includes hardware or a combination of hardware and software. In various embodiments, a module may be considered part of, or a component of, or implemented using one or more of the components of a communication node of FIG. 1, including a processor 110, a memory 112, a transceiver circuit 106, or the antenna 108. For example, the processor 110, such as when executing computer code stored in the memory 112, may perform the functions of a module. Additionally, in various embodiments, the functions that a module performs may be defined by one or more standards or protocols, such as 5G NR for example. In various embodiments, the PHY module 202, the MAC module 204, the RLC module 206, the PDCP module 208, and RRC module 210 may be, or the functions that they perform may be, part of a plurality of protocol layers (or just layers) into which various functions of the communication node are organized and/or defined. Also, in various embodiments, among the five modules 202-210 in FIG. 2, the PHY module 202 may be or correspond to the lowest layer, the MAC module 204 may be or correspond to the second-lowest layer (higher than the PHY module 202), the RLC module 206 may be or correspond to the third lowest layer (higher than the PHY module 202 and the MAC module 204), the PDCP module 208 may be or correspond to the fourth-lowest layer (higher than the PHY module 202, the MAC module 204, and the RLC module 206), and the RRC module 210 may be or correspond to the fifth lowest layer (higher than the PHY module, the MAC module 204, the RLC module 206, and the PDCP module 208). Various other embodiments may include more or fewer than the five modules 202-210 shown in FIG. 2, and/or modules and/or protocol layers other than those shown in FIG. 2.

The modules of a communication node shown in FIG. 2 may be perform various functions and communicate with each other, such as by communicating signals or messages between each other, in order for the communication node to send and receive signals. The PHY layer module 202 may perform various functions related to encoding, decoding, modulation, demodulation, multi-antenna mapping, as well as other functions typically performed by a physical layer.

The MAC module 204 may perform or handle logical-channel multiplexing and demultiplexing, hybrid automatic repeat request (HARQ) retransmissions, and scheduling-related functions, including the assignment of uplink and downlink resources in both the frequency domain and the time domain. Additionally, the MAC module 204 may determine transport formats specifying how a transport block is to be transmitted. A transport format may specify a transport-block size, a coding and modulation mode, and antenna mapping. By varying the parameters of the transport format, the MAC module 204 can effect different data rates. The MAC module 204 may also control distributing data from flows across different component carriers or cells for carrier aggregation.

The RLC module 206 may perform segmentation of service data units (SDU) to suitably sized protocol data units (PDU). In various embodiments, a data entity from/to a higher protocol layer or module is called a SDU, and the corresponding data entity to/from a lower protocol layer or module is called a PDU. The RLC module 206 may also perform retransmission management that involves monitoring sequence numbers in PDUs in order to identify missing PDUs. Additionally, the RLC module 206 may communicate status reports to enable retransmission of missing PDUs. The RLC module 206 may also be configured to identify errors due to noise or channel variations.

The package data convergence protocol module 208 may perform functions including, but not limited to, Internet Protocol (IP) header compression and decompression, ciphering and deciphering, integrity protection, retransmission management, in-sequence delivery, duplicate removal, dual connectivity, and handover functions.

The RRC module 210 may be considered one of one or more control-plane protocol responsible for connection setup, mobility, and security. The RRC module 210 may perform various functions related to RAN-related control-plane functions, including broadcast of system information; transmission of paging messages; connection management, including setting up bearers and mobility; cell selection, measurement configuration and reporting; and handling device capabilities. In various embodiments, a communication node may communicate RRC messages using signaling radio bearers (SRBs) according to protocols defined by one or more of the other modules 202-210.

Various other functions of one or more of the other modules 202-210 may be possible in any of various embodiments.

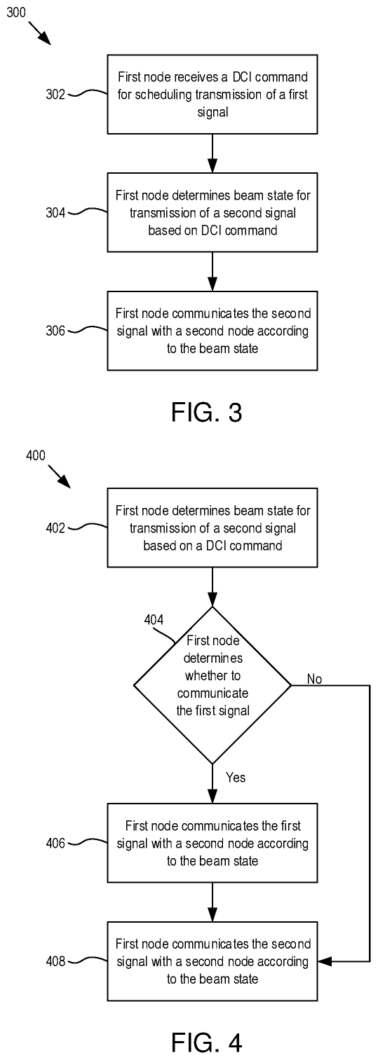

FIG. 3 is a flow chart of an example method 300 for wireless communication. At block 302, a first node receives a downlink control information (DCI) command, such as from a second node. In various embodiments, the first node that receives the DCI command is a user device, and the second node is a wireless access node. In addition, in various embodiments, the DCI command is generated and sent to the first node in order to schedule transmission of the first signal. Scheduling the transmission may include various tasks, such as determining one or more resources involved to communicate (transmit or receive) the first signal, a beam (such as a transmit beam or a receive beam) with which to communicate the first signal, and/or a time at which to communicate the first signal, as non-limiting examples. In addition, in various embodiments, the first signal includes at least one of: a PDCCH, a PUCCH, a CSI-RS, a SRS, a PUSCH, or a PDSCH.

At block 304, in response to, or based on, receiving the DCI command, the first node may determine a beam state for transmission of the second signal. In various embodiments, the second signal includes at least one of: a PDCCH, a PUCCH, a PUSCH, a PDSCH, a CSI-RS, or a SRS. Also, in general, a beam state is a set of one or more parameters that a communication node uses to communicate signals with one or more other communication nodes. In at least some embodiments, some or all of the parameters are defined by and/or used in accordance with 5G NR. In addition or alternatively, a beam state comprises at least one of: one or more quasi co-location (QCL) states, one or more transmission configuration indicator (TCI) states, spatial relation information, reference signal information, spatial filter information, or precoding information. In an embodiment, the second signal is not scheduled by the DCI command. In an embodiment, the second signal is different from the first signal, such as with different types, or with different communication resources (at least including frequency domain, time domain).

Also, for at least some embodiments, the DCI command includes beam state information that the first node uses to determine the beam state. For example, the beam state information may explicitly indicate the beam state, or may implicitly indicate the beam state, such as by including a value, such as an index value, that indicates the beam state. Also, for at least some embodiments, the beam state information included in a DCI command may be included in at least one TCI field or at least one reference signal resource indicator (SRI) field.

Also, for at least some embodiments, a DCI command indicates one of a plurality of predetermined combinations of beam states, where each predetermined combination includes one or more beam states. For such embodiments, the first node may determine the beam state for the transmission of the first signal and/or for transmission of the second signal by determining which of the plurality of possible beam state combinations is indicated in the DCI command. For at least some embodiments, each predetermined combination is associated with a respective beam state indication value, and the beam state indication value may be included in the DCI command. Upon receipt of the DCI command, the first node may identify the beam state indication value, and in turn, determine the beam state combination. In particular embodiments, the first node may be configured with a lookup table that associates beam state indication values with predetermined beam state combinations. An example lookup table is provided as follows:

TABLE 1
Example lookup table mapping beam state indication
values and predetermined beam state combinations

| beam state indication value | First beam state | Second beam state |
|---|---|---|
| 0 | beam state #0 | none |
| 1 | beam state #1 | none |
| 2 | beam state #0 | beam state #1 |

In the example lookup Table 1, the wireless system 100 uses three predetermined beam state combinations of two beam states (beam state #0 and beam state #1), where each predetermined beam state combination includes one or more beam states. For example, a first beam state combination includes only beam state #0, a second beam state combination includes only beam state #1, and a third beam state combination includes beam state #0 and beam state #1. Each predetermined beam state combination is associated with a respective one of a plurality of beam state indication values. A given beam state indication value may be included in a DCI command. Upon receipt of the DCI command, the first node may determine the given beam state indication value, and then, using the lookup table, determine a predetermined beam state combination. The first node may then determine to use that beam state combination for the beam state for transmission of the first and second signals.

Additionally, for at least some embodiments where the beam state is indicated in at least one TCI field of the DCI command, the DCI command has a DCI format 1_1, a DCI format 1_2, a DCI format 0_1, or a DCI format 0_2. Additionally, for at least some embodiments where the beam state is indicated in at least one SRI field of the DCI command, the DCI command has a DCI format 0_1 or a DCI format 0_2.

In addition or alternatively, in various embodiments where the beam state is indicated in at least one SRI field, and the second signal is a downlink signal, the beam state indicated by the at least one SRI field may include (e.g., only include) a QCL type D reference signal. In addition or alternatively, in various embodiments where the beam state is indicated in at least one TCI field, and the second signal is an uplink signal, the beam state indicated by the at least one TCI field may include (e.g., only include) a QCL type D reference signal.

As mentioned, for some example embodiments, the second signal may be a PDCCH. In various of these embodiments, the PDCCH is a PDCCH in all control resource sets (CORESETs) in a bandwidth part or a cell, a PDCCH in a CORESET on which the first node receives the DCI command, a PDCCH in a CORESET pool on which the first node receives the DCI command, a PDCCH in a CORESET or a CORESET pool that is associated with the beam state indicated in the DCI command, or a PDCCH that is related to a same CORESET or a same CORESET pool as the DCI command.

For other example embodiments, the second signal is a PUCCH, as mentioned. In various of these embodiments, the PUCCH may be a PUCCH in all PUCCH resources in a bandwidth part or a cell, a PUCCH indicated by a PUCCH resource indicator (PRI) in the DCI command, a PUCCH belonging to a same PUCCH resource group indicated by a PUCCH resource indicator in the DCI command, or a PUCCH associated with a spatial relationship related to (such as by having a QCL relationship with) a CORESET in which the first node receives the DCI command. In general, a user device may be configured with a plurality of PUCCH resources used for the PUCCH transmission, and the user device can use the determined beam state to update the beam state of at least one PUCCH resource with which the first node is configured. Also, in general, for uplink communication, when a PUCCH transmission is scheduled, a PUCCH resource may be indicated by the wireless access node. Additionally, in general, for downlink communication, a user device may be configured with one or more CORESETs. The user device may monitor occasions indicated by the one or more CORESETs.

For still other embodiments, the second signal may be a reference signal (RS), such as a SRS or a CSI-RS, as mentioned. For such embodiments, the reference signal includes a reference signal with all or part of configured RS resources, a reference signal with all or part of RS resources in a bandwidth part or a cell, or a reference signal with a reference signal (RS) resource determined by a RS resource set index or a RS resource index. In various of these embodiments, the RS resource index is activated by the DCI command. For at least some of these embodiments, the RS source is in a RS resource set that includes a highest resource set index or a lowest resource set index among a plurality of resource set indices for a plurality of RS resource sets activated by the DCI command.

Also, in various embodiments, where the second signal is a PDCCH, a PUCCH, a PDSCH, a PUSCH, or a RS, the bandwidth part or the cell is determined according to the DCI command. For at least some of these embodiments, the bandwidth part or the cell includes: a bandwidth part or a cell where the DCI command is transmitted; a first bandwidth part or a first cell related to a second bandwidth part or a second cell where the DCI command is transmitted (e.g., by predetermined mapping); or a first bandwidth part or a first cell belonging to a same group as a second bandwidth part or a second cell where the DCI command is transmitted.

For still other embodiments, the second signal may be a PUSCH. In various of these embodiments, the PUSCH is scheduled to be transmitted or activated by a second DCI command, or the PUSCH is configured according to RRC parameters, such as ConfiguredGrantConfig. Also, in various embodiments, the first node, or the second node, may update a SRS resource indicator (SRI) (e.g., a SRI in rrc-ConfiguredUplinkGrant) with beam state information in the DCI command for a configured-grant type 1 PUSCH, and/or may update a SRI in a DCI command that activated or caused the PUSCH transmission with or by beam state information in the DCI command for a configured-grant type 2 PUSCH. Here, a configured-grant type 1 PUSCH transmission refers to a PUSCH transmission configured by ConfiguredGrantConfig, where rrc-ConfiguredUplinkGrant is included in ConfiguredGrantConfig. In addition, a configured-grant type 2 PUSCH transmission refers to a PUSCH transmission configured by ConfiguredGrantConfig, where rrc-ConfiguredUplinkGrant is not included in ConfiguredGrantConfig. Also, in various embodiments, whether a configured-grant type (either type 1 or type 2) PUSCH allow the first node or the second node to update the beam state or communicate the PUSCH according to the beam state may depend on higher layer signaling (e.g, higher than the physical layer (PHY)).

Also, in various embodiments, the first node, or the second node, determines a SRI of the PUSCH according to the beam state based on the DCI command. Also, in various embodiments where the second signal is a PUSCH, the PUSCH transmission is a codebook-based PUSCH transmission or a non-codebook based PUSCH transmission. For at least some of these embodiments, the beam state from the DCI command, the first node determines a SRS resource for transmission of the codebook-based PUSCH or transmission of the non-codebook-based PUSCH. In addition, for at least some of these embodiments, the first node determines a SRS resource for the codebook-based PUSCH transmission or the non-codebook-based PUSCH transmission. For at least some of these embodiments, the beam state comprises one of a plurality of beam states, and the first node determines one or more SRS resources for the non-codebook-based PUSCH transmission based on the plurality of beam states.

In still other example embodiments, the second signal is a PDSCH. For such embodiments, the first node may schedule the PDSCH transmission by the DCI command, where the DCI command has a DCI format 1_0, a DCI format 1_1, or a DCI format 1_2.

Additionally, in various embodiments, the DCI command is a most recent DCI command that includes the beam state received prior to receiving a second DCI command that schedules the second signal transmission.

In addition or alternatively, in various embodiments, the first node may determine the beam state for transmission of the second signal based on the DCI command according to a second transmission parameter. In general, a second transmission parameter may include any data or information that indicates to a node whether to determine a beam state for the second signal. Additionally, for at least some of these embodiments, the second transmission parameter is included in RRC signaling, MAC layer signaling (e.g., a medium access control control element (MAC-CE) commands), or physical layer signaling. In addition or alternatively, the first node determines the beam state based on the DCI command according to the second transmission parameter in response to, or when, the second transmission parameter is enabled or provided. For at least some of these embodiments, the second transmission parameter is provided for a type of second signal, such as at least one of a PDCCH, a PUCCH, a CSI-RS, a SRS, a PDSCH, or a PUSCH. In addition or alternatively, the type of second signal is determined according to one of: a predetermined type of second signal, a configured type of second signal (e.g., configured by RRC signaling), an indicated type of second signal (e.g., indicated by physical layer signaling), or a DCI format of the DCI command.

For example, in various embodiments, the second transmission parameter in the DCI command includes an N-bit binary value, where N is an integer of 1 or more. Accordingly, a given N-bit binary value may be one of 2N possible binary values. Each binary value may indicate whether the second transmission parameter is enabled for one or more given second signal types. In particular embodiments, a given signal type is a PDCCH or a PUCCH. To illustrate, in a particular example embodiment where N is two, a 2-bit value “00” indicates that the beam state included in the DCI command is not used to determine the beam state of a PDCCH transmission and/or a PUCCH transmission; a 2-bit value “01” indicates that the beam state included in the DCI command is not used to determine the beam state of a PDCCH transmission, but can be used for the beam state of a PUCCH transmission; a 2-bit value “11” indicates that the beam state included in the DCI command is used to determine the beam state of a PDCCH transmission and the beam state of a PUCCH transmission.

For another example, the second transmission parameter in the DCI command includes a 1-bit binary value that indicates whether the second transmission parameter is enabled for a predetermined or a configured type of second signal, e.g. a PDCCH. A 1-bit binary value “0” indicates that the beam state included in the DCI command is not used to determine the beam state of the configured type of second signal (e.g., a PDCCH); and a 1-bit binary value “1” indicates that the beam state included in the DCI command is used to determine the beam state of the configured type of second signal (e.g., a PDCCH).

Additionally, in various embodiments, the predetermined or configured type of second signal may be a PDCCH and/or a PUCCH; and/or the type of second signal is related to the DCI format. For example, the beam state of a PDCCH transmission is determined according to the DCI format 1_1 or 1_2; and/or the beam state of a PUCCH transmission is determined according to the DCI format 0_1 or 0_2.

Also, in various embodiments, the beam state that the first node determines based on the DCI command is one of a plurality of beam states of a beam state group. For at least some of these embodiments, the beam state group is related to or associated with one or more types of second signal, such as at least one of a PDCCH, a PUCCH, a CSI-RS, a SRS, a PDSCH, or a PUSCH. In addition or alternatively, the beam state group is determined according to MAC layer signaling or RRC signaling.

In addition or alternatively, in various embodiments, the first node may determine the beam state for the transmission of the second signal based on the DCI command after a predetermined time point, or after a predetermined time period after a predetermined time point. In various embodiments, the predetermined time point is one of: a time of receiving the DCI command, a time of the transmission of the second signal, a time of a second DCI command which schedules the second signal, or a time that a response signal related to the DCI command is communicated. In particular embodiments, the time of receiving the DCI command corresponds to a time of receiving a last symbol of a PDCCH transmission that includes the DCI command, or an initial symbol immediately after the last symbol. In addition or alternatively, in various embodiments, the predetermined time period comprises one or more time units, where each time unit includes a slot, a symbol, a radio frame, a physical frame, a sub-frame of the radio frame or the physical frame, or a seconds-based unit (e.g., milliseconds, microseconds, nanoseconds, etc.). In an embodiment, the predetermined time period comprises 3 slots. In an embodiment, the predetermined time period depends on UE capability.

Additionally, in various embodiments, the first node may transmit a response signal to the second node in response to receiving the DCI command. For such embodiments, the predetermined time point corresponds to a time at which the first node transmits the response signal. For at least some embodiments, the response signal is a PUSCH scheduled by the DCI command, a first hybrid automatic repeat request (HARQ) signal for a PDSCH transmission scheduled by the DCI command, or a second HARQ signal for the DCI command. In various of these embodiments, when the response signal includes the first HARQ signal, the HARQ signal is a positive acknowledgment (HARQ-ACK) or a negative acknowledgment (HARQ-NACK).

Also, for at least some embodiments where the response signal includes a PUSCH, the first node determines the beam state for the transmission of the second signal after the predetermined time period after the predetermined time point dependent on: the first node not detecting any other DCI commands before the predetermined time point, or before the predetermined time period after the predetermined time point; or the first node detecting one or more other DCI commands before the predetermined time period after the predetermined time point and the one or more other DCI commands is not used to determine the beam state of the second signal.

Also, for at least some embodiments where the response signal includes a PUSCH, the first node detects a second response signal from the second node before the predetermined time point, or before the predetermined time period after the predetermined time point. Upon doing so, the first node determines the beam state for the transmission of the second signal after the predetermined time period after the predetermined time point, or after a second predetermined time period after the predetermined time point. Also, for at least some of these embodiments, where the second response signal comprises a DCI format, the second node schedules a second PUSCH transmission with a same hybrid automatic repeat request (HARQ) process number as for a first PUSCH transmission of the first response signal with a toggled new-data indicator (NDI) field value.

At block 306, the first node may communicate the second signal with a second node according to the beam state. As non-limiting examples, the first node may communicate the second signal according to a scheduling indicated by the beam state, may communicate with a selected beam (e.g., a transmit beam or a receive beam) indicated by the beam state, may encode, decode, modulate, or demodulate according to the beam state, and/or using one or more resources indicated by the beam state. In various embodiments, the first node may communicate the second signal with the second node by either transmitting the second signal to the second node, or by receiving the second signal from the second node. Also, in various embodiments, the first node may communicate the second signal after communicating the first signal, may communicate the second signal before communicating the first signal, or may communicate the second signal without communicating the first signal. For such latter situations, the first node may determine the beam state for a first transmission, such as based on a DCI command, but then expressly determine not to communicate the first signal.

Additionally, for at least some embodiments, the first node may determine whether to communicate the first signal with the second node. For example, in various embodiments, when a location of a user device changes, the wireless access node may need to update a beam that the user device uses to communicate with the wireless access node. If there is a need to communicate data between the wireless access node and the user device, the nodes may use a DCI command to schedule transmission of a first signal (on a PDSCH or a PUSCH) to communicate the data, and may further use the beam state information in the DCI command to determine the beam state for transmission of a second signal. However, in various situations, the two nodes may not have data to communicate, and so therefore do not have a first signal to communicate with each other. For at least some of these situations, the two nodes may still have determined a beam state for transmission of the first signal, even though the first signal is not communicated, or in some cases not even scheduled by a DCI command to be communicated. For such embodiments, the two nodes may still determine that the beam state information that would have been used to transmit a first signal, can still be used for transmission of a second signal, even though they do not communicate the first signal.

FIG. 4 is an example wireless communication method 400 that determines a beam state for transmission of a second signal based on a DCI command used to schedule transmission of a first signal, and further whether to communicate the first signal. At block 402, the first node may determine a beam state for transmission of a second signal based on a DCI command used for scheduling a transmission of a first signal, as previously described for block 304 of FIG. 3. At block 404, the first node may determine whether to communicate the first signal with the second node. In various embodiments, the first node may use a first transmission parameter to determine whether to communicate the first signal with the second mode. In general, a first transmission parameter may include any data or information that indicates to a node whether to communicate the first signal. In various embodiments, the first node may use RRC signaling, physical layer (PHY) signaling, or MAC layer signaling (e.g., a media access control element (MAC-CE) command) to carry the first transmission parameter.

In addition, in various embodiments, the first node may determine not to communicate the first signal in response to the first transmission parameter indicating not to communicate the first signal, or an absence of the first transmission parameter. On the other hand, the first node may determine to communicate the first signal in response to first transmission parameter indicating to communicate the first signal, or a presence of the first transmission parameter. Herein, a presence of the first transmission parameter may refer to a parameter that is provided to a node, or with which the node is configured or reconfigured. Accordingly, an absence of the first transmission parameter may refer to a parameter that is not provided to a node, or with which the node is not configured or not reconfigured.

In other example embodiments, a DCI command is used to carry, include, or indicate the first transmission parameter. For at least some of these embodiments, the first signal comprises an uplink signal, and the DCI command includes an uplink shared channel (UL-SCH) indicator that includes the first transmission parameter. For at least some of these embodiments, the UL-SCH indicator includes a ‘0’ value to indicate not to communicate the uplink signal. In addition or alternatively, the DCI command may include a CSI request field that includes a value indicating not to send a CSI report. Such embodiments allow a DCI command to include both a US-SCH indicator field having a ‘0’ value and a CSI request field indicating not to send a CSI report. In various embodiments, the first node may utilize RRC protocols and/or signaling to configure the DCI command to indicate both not to communicate an uplink signal and not to send a CSI report.

In addition, for at least some other embodiments, the first signal comprises a downlink signal, and the DCI command includes a downlink shared channel (DL-SCH) indicator field that comprises the first transmission parameter. For at least some of these embodiments, the DL-SCH indicator includes a ‘0’ value to indicate not to communicate the downlink signal. In various embodiments, the first node may utilize RRC protocols and/or signaling to include the first transmission parameter in the DL-SCH indicator field to indicate whether to communicate the first signal.

At block 404, if the first node determines to communicate the first signal, then at block 406, the first node may communicate the first signal according to the beam state determined at block 402 with the second node. At block 408, the first node may communicate the second signal according to the beam state determined at block 402. In various embodiments, such as indicated in FIG. 4, the first node may communicate the first signal first, and then communicate the second signal. In other embodiments, the first node may communicate the second signal first, and then communicate the first signal. Various ways and/or orders of communicating both the first signal and the second signal may be possible. Referring back to block 404, if the first node determines not to communicate the first signal, then the method 400 may proceed directly to block 408, where the first node communicates the second signal without communicating the first signal. Additionally, in various embodiments, the first node may determine to the beam state for transmission of the second signal before determining whether to communicate the first signal, as indicated in FIG. 4. In other embodiments, the first node may determine whether to communicate the first signal before determining the beam state for transmission of the second signal.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
receiving, by a first node, a downlink control information (DCI) command scheduling a transmission of a physical downlink shared channel (PDSCH);
determining, by the first node, a transmission configuration indicator (TCI) state for a transmission of a second signal based on the DCI command; and
communicating, by the first node, the second signal with a second node according to the TCI state.

2. The method of claim 1, wherein the second signal comprises at least one of: a physical downlink control channel (PDCCH), a physical uplink control channel (PUCCH), a channel-state information reference signal (CSI-RS), a sounding reference signal (SRS), an physical uplink shared channel (PUSCH), or a physical downlink shared channel (PDSCH).

3. The method of claim 1, wherein determining, by the first node, the beam state for the transmission of the second signal based on the DCI command, further comprises:
determining, by the first node, the beam state for the transmission of the second signal based on the DCI command according to a second transmission parameter.

4. The method of claim 3, wherein determining, by the first node, the beam state for the transmission of the second signal based on the DCI command according to the second transmission parameter comprises:
determining, by the first node, the beam state for the transmission of the second signal based on the DCI command according to the second transmission parameter in response to the second transmission parameter being enabled or provided.

5. The method of claim 3, wherein the type of second signal comprises at least one of: a physical downlink control channel (PDCCH), a physical uplink control channel (PUCCH), a channel-state information reference signal (CSI-RS), a sounding reference signal (SRS), a physical downlink shared channel (PDSCH), or a physical uplink shared channel (PUSCH).

6. The method of claim 1, wherein determining, by the first node, the beam state for the transmission of the second signal based on the DCI command comprises:
determining, by the first node, the beam state for the transmission of the second signal based on the DCI command after a predetermined time point, or after a predetermined time period after the predetermined time point.

7. The method of claim 6, wherein the response signal comprises a physical uplink shared channel (PUSCH) scheduled by the DCI command, a first hybrid automatic repeat request (HARQ) signal for a physical downlink shared channel (PDSCH) transmission scheduled by the DCI command, or a second HARQ signal for the DCI command.

8. A wireless communications apparatus comprising:
a memory storing a plurality of instructions; and
a processor configured to execute the plurality of instructions, and upon execution of the plurality of instructions, is configured to:
receive a downlink control information (DCI) command scheduling a transmission of a physical downlink shared channel (PDSCH);
determine a transmission configuration indicator (TCI) state for a transmission of a second signal based on the DCI command; and
communicate the second signal with a second node according to the TCI state.

9. The wireless communications apparatus of claim 8, wherein the second signal comprises at least one of: a physical downlink control channel (PDCCH), a physical uplink control channel (PUCCH), a channel-state information reference signal (CSI-RS), a sounding reference signal (SRS), a physical uplink shared channel (PUSCH), or a physical downlink shared channel (PDSCH).

10. The wireless communications apparatus of claim 8, wherein the processor is configured to determine the TCI state for the transmission of the second signal according to a second transmission parameter in a radio resource control (RRC) signaling.

11. The wireless communications apparatus of claim 10, wherein the second communication parameter is configured as enabled.

12. The wireless communications apparatus of claim 10, wherein the second signal comprises at least one of: a physical downlink control channel (PDCCH), a sounding reference signal (SRS), or a physical downlink shared channel (PDSCH).

13. The wireless communications apparatus of claim 8, wherein the processor, upon execution of the plurality of instructions, is configured to determine the TCI state for the transmission of the second signal based on the DCI command after one or more symbols after a time that a response signal associated with the DCI command is communicated.

14. The wireless communications apparatus of claim 13, wherein the response signal comprises a hybrid automatic repeat request (HARD) signal for the PDSCH.

15. A method for wireless communication, comprising:
transmitting, by a second node, a downlink control information (DCI) command scheduling a transmission of a physical downlink shared channel (PDSCH), wherein the DCI command indicates to a first node receiving the DCI command to determine a transmission configuration indicator (TCI) state for a transmission of a second signal based on the DCI command; and
communicating, by the second node, the second signal with the first node according to the TCI state.

16. The method of claim 15, wherein the second signal comprises at least one of: a physical downlink control channel (PDCCH), a physical uplink control channel (PUCCH), a channel-state information reference signal (CSI-RS), a sounding reference signal (SRS), a physical uplink shared channel (PUSCH), or a physical downlink shared channel (PDSCH).

17. The method of claim 15, wherein the TCI state for the transmission of the second signal is determined according to a second transmission parameter in a radio resource control (RRC) signaling.

18. The method of claim 17, wherein the second transmission parameter is configured as enabled.

19. The method of claim 17, wherein the second signal comprises at least one of: a physical downlink control channel (PDCCH), a sounding reference signal (SRS), or a physical downlink shared channel (PDSCH).

20. The method of claim 15, wherein the TCI state for the transmission of the second signal based on the DCI command is determined after one or more symbols after a time that a response signal associated with the DCI command is communicated.

21. The method of claim 20, wherein the response signal comprises a hybrid automatic repeat request (HARD) signal for the PDSCH scheduled by the DCI command.

22. A wireless communications apparatus comprising:
a memory storing a plurality of instructions; and
a processor configured to execute the plurality of instructions, and upon execution of the plurality of instructions, is configured to:
transmit a downlink control information (DCI) command scheduling a transmission of a physical downlink shared channel (PDSCH), wherein the DCI command indicates to a first node receiving the DCI command to determine a transmission configuration indicator (TCI) state for a transmission of a second signal based on the DCI command; and
communicate the second signal with the first node according to the TCI state.

23. The wireless communications apparatus of claim 22, wherein the second signal comprises at least one of: a physical downlink control channel (PDCCH), a physical uplink control channel (PUCCH), a channel-state information reference signal (CSI-RS), a sounding reference signal (SRS), a physical uplink shared channel (PUSCH), or a physical downlink shared channel (PDSCH).

24. The wireless communications apparatus of claim 22, wherein the TCI state for the transmission of the second signal is determined according to a second transmission parameter in a radio resource control (RRC) signaling.

25. The wireless communications apparatus of claim 24, wherein the second transmission parameter is configured as enabled.

26. The wireless communications apparatus of claim 24, wherein the second signal comprises at least one of: a physical downlink control channel (PDCCH), a sounding reference signal (SRS), or a physical downlink shared channel (PDSCH).

27. The wireless communications apparatus of claim 22, wherein the TCI state for the transmission of the second signal based on the DCI command is determined after one or more symbols after a time that a response signal associated with the DCI command is communicated.

28. The wireless communications apparatus of claim 27, wherein the response signal comprises a hybrid automatic repeat request (HARD) signal for the PDSCH scheduled by the DCI command.
